(19) United States
(12) Patent Application Publication
(10) Pub. No.: US 2025/0247795 A1
(43) Pub. Date: Jul. 31, 2025

(54) IN-VEHICLE COMMUNICATION DEVICE, COMMUNICATION CONTROL METHOD, AND NON-TRANSITORY STORAGE MEDIUM

(71) Applicant: TOYOTA JIDOSHA KABUSHIKI KAISHA, Toyota-shi (JP)

(72) Inventors: Hiroshi ABE, Kasukabe-shi (JP); Koji Takeoka, Yokohama-shi (JP); Kiichi Iwasaki, Nagoya-shi (JP); Takayuki Sakai, Tokyo-to (JP); Isao Nishioka, Nagoya-shi (JP); Yasuhiro Kobatake, Nagoya-shi (JP); Noriaki Ito, Okazaki-shi (JP)

(73) Assignee: TOYOTA JIDOSHA KABUSHIKI KAISHA, Toyota-shi (JP)

(21) Appl. No.: 19/028,632

(22) Filed: Jan. 17, 2025

(30) Foreign Application Priority Data
Jan. 26, 2024 (JP) 2024-010199

(51) Int. Cl. H04W 52/18; B60L 58/30

(52) U.S. Cl. CPC H04W 52/18; B60L 58/30

(57) ABSTRACT

An in-vehicle communication device mounted in a vehicle, comprises a control unit that determines transmission power for wireless communication on a basis of whether a current charging mode corresponds to a first mode or a second mode with respect to the wireless communication using the in-vehicle communication device performed when the vehicle is in a parked state and in a charging state where a secondary cell that supplies power to a motor provided in the vehicle is being charged.

### CROSS REFERENCE TO THE RELATED APPLICATION

This application claims the benefit of Japanese Patent Application No. 2024-010199, filed on Jan. 26, 2024, which is hereby incorporated by reference herein in its entirety.

### BACKGROUND

### Technical Field

The present disclosure relates to an in-vehicle communication device, a communication control method, and a non-transitory storage medium.

### Description of the Related Art

Conventionally, in-vehicle communication devices allowing Wi-Fi connections have been known (for example, Japanese Patent Application Laid-open No. 2022-062548).

It is an object of the present disclosure to provide an in-vehicle communication device, a communication control method, and a non-transitory storage medium capable of setting transmission power for wireless communication to a suitable level in a vehicle that is in a parked and charging state.

### SUMMARY

An aspect of the present disclosure provides an in-vehicle communication device mounted in a vehicle, including: a control unit that determines transmission power for wireless communication on a basis of whether a current charging mode corresponds to a first mode or a second mode with respect to the wireless communication using the in-vehicle communication device performed when the vehicle is in a parked state and in a charging state where a secondary cell that supplies power to a motor provided in the vehicle is being charged.

Another aspect of the present disclosure provides a communication control method including: determining, by an in-vehicle communication device mounted in a vehicle, transmission power for wireless communication on a basis of whether a current charging mode corresponds to a first mode or a second mode with respect to the wireless communication using the in-vehicle communication device performed when the vehicle is in a parked state and in a charging state where a secondary cell that supplies power to a motor provided in the vehicle is being charged.

Another aspect of the present disclosure provides a non-transitory (computer-readable) storage medium storing a program that causes a computer of an in-vehicle communication device mounted in a vehicle to perform: a step of determining transmission power for wireless communication on a basis of whether a current charging mode corresponds to a first mode or a second mode with respect to the wireless communication using the in-vehicle communication device performed when the vehicle is in a parked state and in a charging state where a secondary cell that supplies power to a motor provided in the vehicle is being charged.

Another aspect of the present disclosure may include an information processing system including the in-vehicle communication device described above, or the like.

According to the present disclosure, it is possible to set transmission power for wireless communication to a suitable level in a vehicle that is in a parked and charging state.

### BRIEF DESCRIPTION OF THE DRAWINGS

FIG. 1 is a diagram illustrating a configuration example of an information processing system;

FIG. 2 is a diagram illustrating a configuration example of an in-vehicle communication device;

FIG. 3 is a flowchart illustrating a first processing example of the in-vehicle communication device;

FIG. 4 is a flowchart illustrating a second processing example of the in-vehicle communication device;

FIG. 5 is a flowchart illustrating a third processing example of the in-vehicle communication device; and

FIG. 6 is a flowchart illustrating a fourth processing example of the in-vehicle communication device.

### DESCRIPTION OF THE EMBODIMENTS

Hereinafter, an embodiment of an in-vehicle communication device, a communication control method, and a program will be described with reference to the drawings.

Note that in all the drawings of the following embodiment, the same or corresponding components will be denoted by the same symbols. Further, the present disclosure is not limited to the embodiment that will be described below.

### Information Processing System

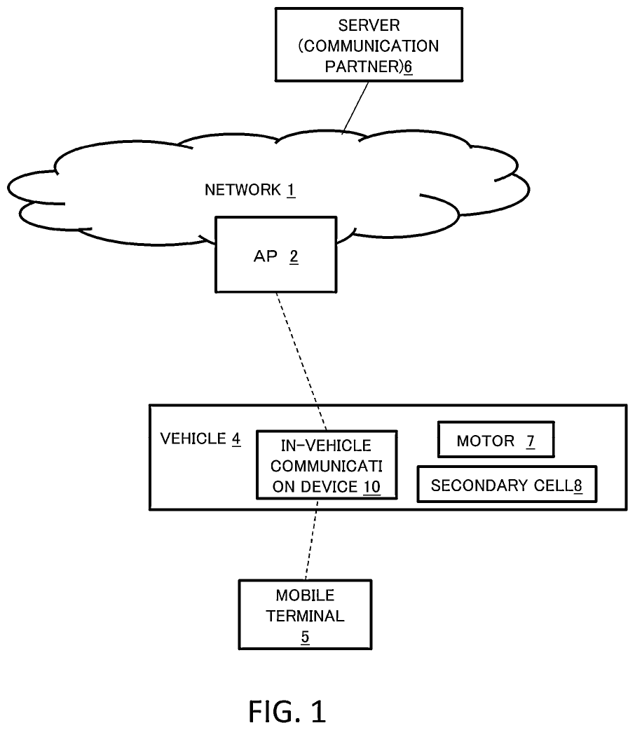

FIG. 1 is a diagram illustrating a configuration example of an information processing system. In FIG. 1, the information processing system is a system that allows a vehicle 4 to communicate with a communication partner (for example, a server 6) connected to a network 1.

The network 1 is, for example, a public communication network such as the Internet. The network 1 is connected to a Local Area Network (LAN) serving as an access network, and the LAN includes an Access Point (AP) 2 for a wireless LAN. The wireless LAN conforms to or complies with a specified wireless communication standard such as the IEEE802.11 series (including Wi-Fi).

The vehicle 4 is an Electric Vehicle (EV), and includes a motor 7 that drives driving wheels and a secondary cell (referred also to as a storage cell or a charging cell) 8 that supplies driving power to the motor 7. The EV is a Plug-in Hybrid Vehicle (PHEV), a Fuel Cell Vehicle (FCV), a Battery Electric Vehicle (BEV), or the like. The vehicle 4 may be driven by a driver, or may be an unmanned vehicle using automatic driving.

In the vehicle 4, an in-vehicle communication device 10 is mounted. The in-vehicle communication device 10 may be installed in the vehicle 4, or may be detachable from the vehicle 4. The in-vehicle communication device 10 is used to transmit various information such as information (IoT data or the like), which is obtained from various sensors provided in the vehicle 4, to the server 6 via the network 1. Further, the in-vehicle communication device 10 is also capable of operating as an access point (base station) to connect a mobile terminal 5 owned by a driver or a passenger of the vehicle 4 to the network 1. The mobile terminal 5 is, for example, a smart device such as a smartphone and a tablet terminal, a laptop Personal Computer (PC), or the like. Any type of the mobile terminal 5 is acceptable as long as the mobile terminal 5 is capable of communicating with the in-vehicle communication device 10.

### In-Vehicle Communication Device

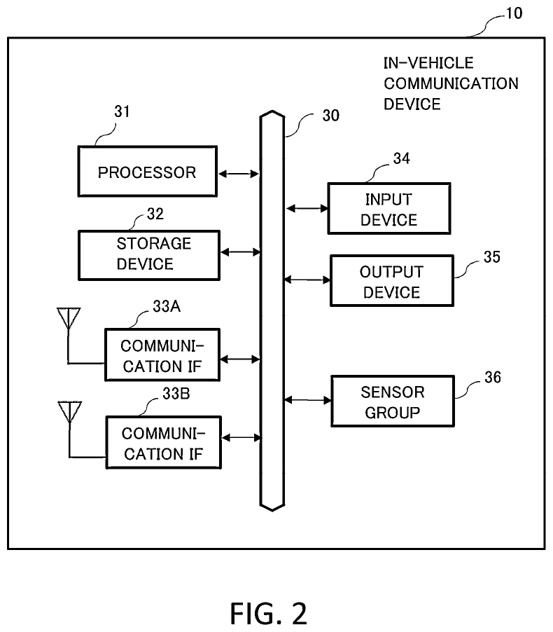

FIG. 2 is a diagram illustrating a configuration example of the in-vehicle communication device 10. In FIG. 2, the in-vehicle communication device 10 includes a processor 31 serving as a processing unit or a control unit (controller), a storage device 32, communication interfaces (communication IFs) 33A and 33B, an input device 34, and an output device 35, all of which are connected to one another via a bus 30.

The storage device 32 includes a main storage device and an auxiliary storage device. The main storage device is used as a storage area for programs and data, a deployment area for programs, a work area for programs, a buffer area for communication data, or the like. The main storage device is composed of a Random Access Memory (RAM) or a combination of a RAM and a Read-Only Memory (ROM). The auxiliary storage device is used as a storage area for data and programs. As the auxiliary storage device, a non-volatile storage medium such as a hard disk, a Solid State Drive (SSD), a flash memory, and Electrically Erasable Programmable Read-Only Memory (EEPROM) is applicable.

The communication IFs 33A and 33B are circuits that perform processing related to wireless communication, each having an antenna for the transmission and reception of radio waves. Each of the communication IFs 33A and 33B performs processing to transmit (emit) and receive radio waves, and operates as a transmission unit and a reception unit (communication unit). The communication IF 33A is used for communication with the AP 2, while the communication IF 33B is used for communication with the mobile terminal 5 (operates as an access point for the mobile terminal 5). The communication IF 33A conforms to or complies with the same wireless communication standard as the AP 2. The communication IF 33B conforms to or complies with the wireless communication standard to or with which the mobile terminal 5 conforms or complies. The wireless communication standard to or with which the communication IF 33B conforms or complies may be the same as or different from the wireless communication standard to or with which the communication IF 33A conforms or complies. Instead of the communication IFs 33A and 33B, a communication device that relays information or data from the vehicle 4 and the mobile terminal 5 to the AP 2 may also be provided.

The input device 34 includes a key, a button, a pointing device, a touch panel, or the like and is used for the input of information. The input device 34 may also include a microphone (sound input device). The output device 35 may be, for example, a liquid-crystal display, an organic EL display, or the like and displays information and data. The output device 35 may also include a speaker (sound output device). A sensor group 36 acquires vehicle-related information from the vehicle 4. As the vehicle-related information, physical data such as the states or temperatures of various mechanisms provided in the vehicle 4 and information indicating the interior or surrounding environment of the vehicle 4 (position information of the vehicle 4, information on surrounding objects, and the like) are acquired. The sensor group 36 may include a camera, a radar, a LiDAR, a GPS receiver, or other measurement equipment depending on the types of information to be collected.

The processor 31 is, for example, a Central Processing Unit (CPU) or the like. The processor 31 performs various processing by running various programs stored in the storage device 32.

For example, the processor 31 performs processing to transmit information or data, which is collected by the sensor group 36, to the AP 2 (the server 6 connected to the network 1) using the communication IF 33A. Further, the processor 31 performs wireless communication with the mobile terminal 5 using the communication IF 33B to transmit and receive data or information to and from the mobile terminal 5. The processor 31 is also capable of performing processing to transmit data or information, which is received from the mobile terminal 5, to the AP 2. The processor 31 controls transmission power for communication with the AP 2 and communication with the mobile terminal 5. The transmission power represents the intensity of radio waves emitted (transmitted) from an antenna. The processor 31 determines (controls) the level of the transmission power according to the state of the vehicle 4.

Note that a plurality of CPUs or a multi-core CPU may also be applied as the processor 31 described above. At least some of the processing performed by the CPU may also be performed by a processor other than the CPU such as a Digital Signal Processor (DSP) and a Graphical Processing Unit (GPU). Further, at least some of the processing performed by the CPU may also be performed by a dedicated or general-purpose integrated circuit (hardware). The integrated circuit includes an Application Specific Integrated Circuit (ASIC), a Field Programmable Gate Array (FPGA), or the like. Alternatively, at least some of the processing performed by the CPU may also be performed by a combination of a processor and an integrated circuit. The combination is referred to as, for example, a Microcontroller (MCU), a System-on-a-chip (SoC), a system LSI, a chipset, or the like. Each of the above processor 31, the integrated circuit, and the combination is an example of circuitry.

### First Processing Example

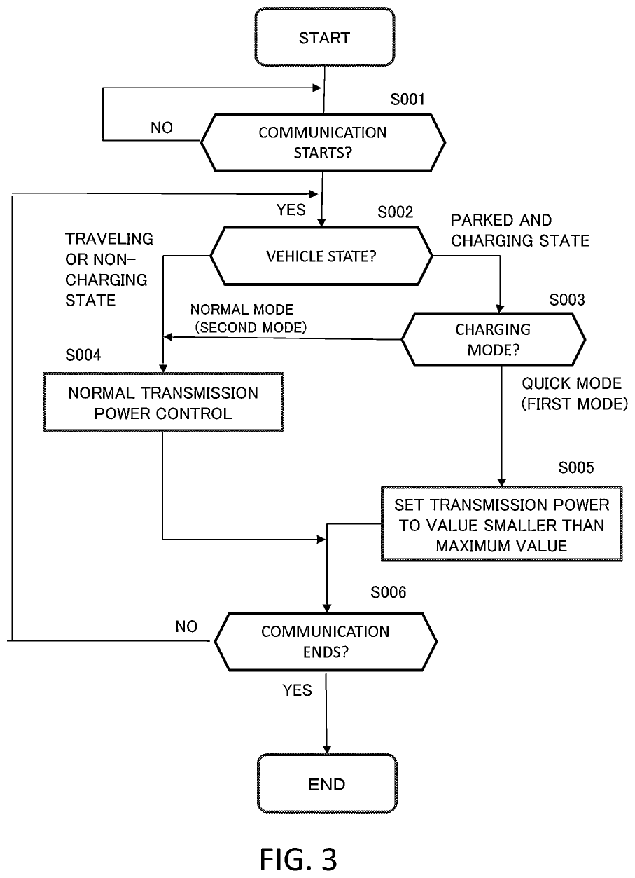

FIG. 3 is a flowchart illustrating a first processing example of the in-vehicle communication device 10. The first processing example is performed when the processor 31 runs a program stored in the storage device 32 or the like. The processing illustrated in FIG. 3 is applicable to at least one (for example, both) of communication using the communication IF 33A and communication using the communication IF 33B.

In step S001, the processor 31 determines whether communication using the communication IF 33A or the communication IF 33B starts. When it is determined that the communication starts, the processing proceeds to step S002.

In step S002, the processor 31 determines the state of a vehicle on the basis of information obtained by the sensor group 36. That is, the processor 31 determines whether the vehicle is in a parked and charging state or in a traveling or non-charging state. The parked state (stopped state) refers to a state where the vehicle 4 remains in a stopped state. A determination as to whether the vehicle is in the parked state or the traveling state is made, for example, by detecting, using the sensor group 36, whether the shift lever of the vehicle 4 is set to “parking” or whether the vehicle 4 remains in the same position for a certain period of time (in other words, the determination is made using information obtained from the sensor group 36 or the like).

The charging state indicates that the secondary cell 8 of the vehicle 4 is being charged. For example, by measuring the voltage between the terminals of the secondary cell 8 using the sensor group 36, it is possible to determine whether the vehicle is in the charging state or the non-charging state. When it is determined in step S002 that the vehicle is in the parked and charging state, the processing proceeds to step S003. Conversely, when it is determined that the vehicle is in the traveling or non-charging state, the processing proceeds to step S004.

In step S003, the processor 31 determines whether a current charging mode corresponds to a quick mode or a normal mode. In the quick mode, a charging amount per unit time is greater than that in the normal mode, allowing charging to be completed in a shorter period of time compared to the normal mode. The quick mode is an example of a first mode where the charging amount per unit time is a first charging amount, while the normal mode is an example of a second mode where the charging amount per unit time is smaller than the first charging amount (the charging amount in the quick mode).

The processor 31 is allowed to determine the charging mode by referring to information indicating the current charging mode, which is stored in the storage device 32, or on the basis of the value of a charging voltage (applied voltage) with respect to the secondary cell 8, which is measured using the sensor group 36. That is, it is determined that the charging mode corresponds to the quick mode when the charging voltage is greater than a threshold. Otherwise, it is determined that the charging mode corresponds to the normal mode. The processing proceeds to step S005 when it is determined that the charging mode corresponds to the quick mode. The processing proceeds to step S004 when it is determined that the charging mode corresponds to the normal mode. The processor 31 determines transmission power for wireless communication on the basis of the determination result in step S003, that is, whether the charging mode corresponds to the quick mode or the normal mode.

When the processing proceeds to step S004, the processor 31 performs normal transmission power control. For example, the processor 31 sets the value of transmission power for communication to an initial value. Then, the processor 31 changes (increases or decreases) the transmission power according to the electric field intensity of radio waves received from a communication partner (the AP 2 or the mobile terminal 5). For example, when the electric field intensity falls below a threshold, the processor 31 incrementally increases the transmission power. For example, a range from a certain value to the maximum value of the transmission power is divided into two or more stages, and the processor 31 sets the transmission power according to the electric field intensity. That is, the processor 31 determines the use of the transmission power according to the electric field intensity. When the processing in step S004 ends, the processing proceeds to step S006.

In step S005, the processor 31 sets the upper limit of the transmission power for communication (the upper limit of the transmission power usable in transmission power control) to a value smaller (lower) than the maximum value of the transmission power, and proceeds the processing to step S006. That is, when the processing proceeds to step S005, the processor 31 determines that the transmission power having a value smaller than the maximum value is used as the transmission power for wireless communication.

Note that in steps S004 and S005, the processor 31 determines and sets the value of the transmission power for communication. However, it may also be possible to employ a configuration where a unit other than the processor 31 determines and sets the value of the transmission power. Information indicating the determined value of the transmission power is output in the form of, for example, a control signal to a circuit that changes the level of the transmission power. Alternatively, the information indicating the determined value of the transmission power may also be transmitted to a circuit that controls the transmission power in the form of data, and the value of the transmission power may also be changed through the interpretation of the data.

In step S006, the processor 31 determines whether the communication ends. When it is determined that the communication does not end, the processing returns to step S002. Conversely, when it is determined that the communication ends, the processor 31 performs processing to end the communication and ends the processing illustrated in FIG. 3.

According to the first processing example, when the vehicle 4 is in a parked and charging state, a determination is made in step S003 as to whether a charging mode corresponds to a quick mode or a normal mode. When the charging mode corresponds to the quick mode, the upper limit of the value of transmission power is set to a value smaller (lower) than the maximum value of the transmission power in step S005. Then, within the range of the set upper limit, the transmission power is incrementally controlled (increased and decreased) according to the electric field intensity of received radio waves. If the transmission power is set to the maximum value during the charging of the secondary cell 8, there is a possibility that the time required for the secondary cell 8 to reach full charging (complete charging) increases. By setting the upper limit of the transmission power to a value smaller than the maximum value, it is possible to achieve earlier completion of the charging.

### Second Processing Example

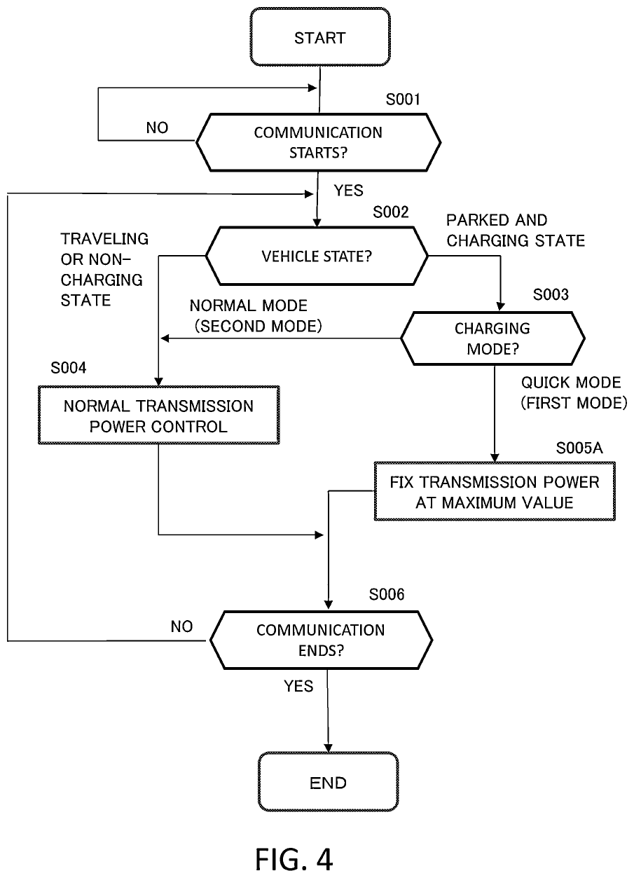

FIG. 4 is a flowchart illustrating a second processing example of the in-vehicle communication device 10. The second processing example is performed when the processor 31 runs a program stored in the storage device 32 or the like. The processing illustrated in FIG. 4 is applicable to at least one (for example, both) of communication using the communication IF 33A and communication using the communication IF 33B.

The processing illustrated in FIG. 4 is the same as that illustrated in FIG. 3 except that step S005A is provided instead of step S005. Therefore, descriptions of steps other than step S005A will be omitted. In step S005A, the processor 31 forcibly sets the value of transmission power to a maximum value. That is, the processor 31 fixes the value of the transmission power at the maximum value.

In the second processing example, transmission power for communication is fixed at a maximum value unlike the first processing example. According to the second processing example, for example, when occupants (such as a driver and passengers) of the vehicle 4 perform communication using the mobile terminal 5 inside the vehicle 4 during charging, it is possible to provide the occupants with a suitable communication environment.

### Third Processing Example

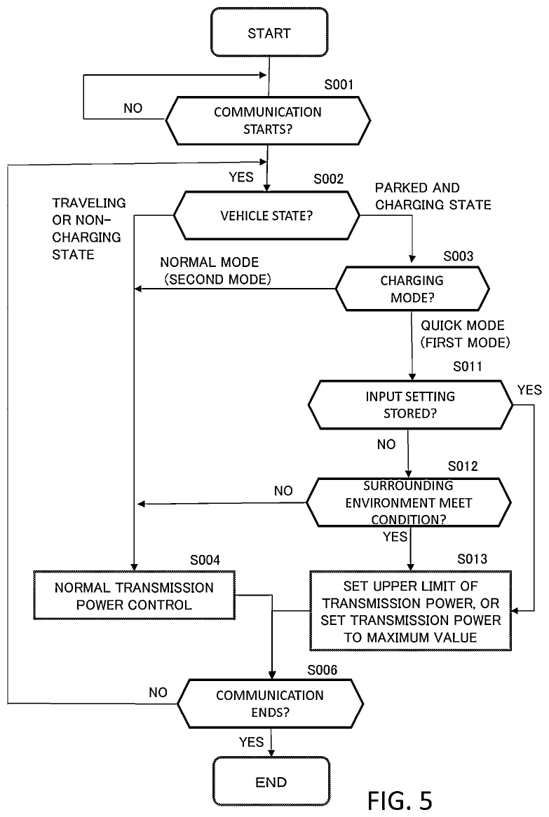

FIG. 5 is a flowchart illustrating a third processing example of the in-vehicle communication device 10. The third processing example is performed when the processor 31 runs a program stored in the storage device 32 or the like. The processing illustrated in FIG. 5 is applicable to at least one (for example, both) of communication using the communication IF 33A and communication using the communication IF 33B.

The processing illustrated in FIG. 5 differs from the first processing example illustrated in FIG. 3 in that step S013 is provided instead of step S005 and steps S011 and S012 are provided between steps S003 and S013.

In step S011, the processor 31 determines whether information indicating an input setting related to transmission power is stored in the storage device 32 in advance. The input setting refers to information indicating whether the upper limit of transmission power is set to a value lower than a maximum value or the transmission power is fixed at the maximum value. An operator of the in-vehicle communication device 10 is allowed to store (set), when the vehicle is in a parked and charging state, the information indicating the input setting in the storage device 32 in advance using the input device 34 or the like. When it is determined that the input setting is stored, the processor 31 proceeds the processing to step S013. Otherwise, the processor 31 proceeds the processing to step S012.

In step S012, the processor 31 determines whether the surrounding environment of the vehicle 4 meets a condition. The condition related to the surrounding environment includes, for example, the condition that the communication IF 33B and the mobile terminal 5 are connected, the condition that the communication IF 33B and the mobile terminal 5 are not connected but radio waves from the mobile terminal 5 are being detected, or the condition that the electric field intensity of radio waves received from the mobile terminal 5 is equal to or above a threshold. However, the condition related to the surrounding environment may also include conditions other than those exemplified above. When it is determined that the condition is met, the processing proceeds to step S013. Otherwise, the processing proceeds to step S004.

In step S013, the processor 31 sets the upper limit of the transmission power. When the processing proceeds from step S011 to step S013, the processor 31 sets the upper limit of the transmission power to a value lower than the maximum value, or sets the transmission power to the maximum value (fixes the transmission power at the maximum value) according to the content of the input setting. When the processing proceeds from step S012 to step S013, the processor 31 fixes the transmission power at the maximum value. This is because communication with the mobile terminal 5 is placed in a suitable state like the second processing example. However, depending on the condition related to the surrounding environment, the upper limit of the transmission power may be set to a value smaller than the maximum value in step S013 if the condition is met. The processing illustrated in FIG. 5 is the same as that illustrated in FIG. 3 except for the above. Therefore, descriptions of the same matters will be omitted.

According to the third processing example, depending on whether an input setting or a condition related to a surrounding environment is met, it is possible to reduce the upper limit of transmission power or fix the transmission power at a maximum value. Each of a determination related to the input setting and a determination as to whether a condition related a surrounding environment is met is optional.

### Fourth Processing Example

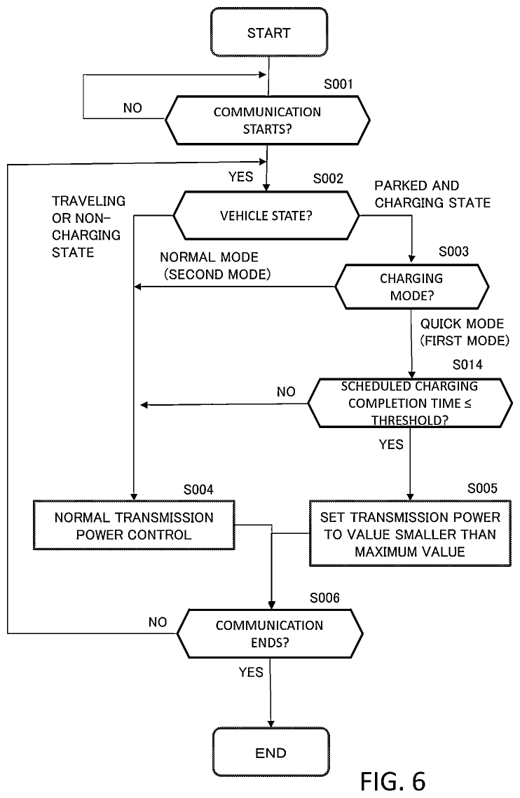

FIG. 6 is a flowchart illustrating a fourth processing example of the in-vehicle communication device 10. The fourth processing example is performed when the processor 31 runs a program stored in the storage device 32 or the like. The processing illustrated in FIG. 6 is applicable to at least one (for example, both) of communication using the communication IF 33A and communication using the communication IF 33B.

The processing illustrated in FIG. 6 differs from the first processing example illustrated in FIG. 3 in that step S014 is provided between steps S003 and S005.

In step S014, the processor 31 determines whether the time length between the current time and the scheduled charging completion time of the secondary cell 8 that is stored in the storage device 32 is equal to or below a threshold. When it is determined that the time length is equal to or below the threshold, the processor 31 sets the upper limit of transmission power to a value smaller than a maximum value (step S005). The processing illustrated in FIG. 6 is the same as that illustrated in FIG. 3 except for the above. Therefore, descriptions of the same matters will be omitted.

In the fourth processing example, when the time required for charging is equal to (or lower than) a threshold, the upper limit of transmission power is reduced to achieve early completion of the charging. However, when it is determined in step S014 that the time length is equal to (or exceeds) the threshold, the transmission power may be fixed at the maximum value. This is because when charging takes a longer time than a threshold, it is considered more important to prioritize suitable communication with the mobile terminal 5.

In the embodiment, the in-vehicle communication device 10 mounted in the vehicle 4 includes the processor 31 (control unit). The processor 31 is capable of performing the following actions for wireless communication using the in-vehicle communication device 10 when the vehicle 4 is in a parked state and in a charging state where the secondary cell 8 that supplies power to the motor 7 provided in the vehicle 4 is being charged. That is, the processor 31 is capable of determining transmission power for wireless communication on the basis of whether a current charging mode corresponds to a quick mode or a normal mode. According to the in-vehicle communication device 10 and a communication control method using the in-vehicle communication device 10, it is possible to set transmission power for wireless communication to a suitable level in a vehicle that is in a parked and charging state.

As illustrated in the first processing example (FIG. 3), when a charging mode corresponds to the quick mode (first mode), the processor 31 is capable of setting the upper limit of transmission power to a value smaller than its maximum value. That is, in the quick mode, it is possible to employ a configuration where the value of transmission power for wireless communication is set to a value smaller than the maximum value of the transmission power.

Conversely, as illustrated in the second processing example (FIG. 4), when a charging mode corresponds to the quick mode (first mode), the processor 31 is capable of fixing transmission power at its maximum value. That is, in the quick mode, it is possible to employ a configuration where the value of transmission power for wireless communication is set to the maximum value of the transmission power.

Further, as illustrated in the third processing example (FIG. 5), the processor 31 (control unit) is capable of determining whether, when a charging mode corresponds to the quick mode, the upper limit of transmission power for wireless communication is set to a value smaller than the maximum value of the transmission power or the transmission power is fixed at the maximum value, on the basis of the following information:
Information indicating an input setting (Information indicating whether the maximum value is usable), or
Information indicating the surrounding environment of the in-vehicle communication device 10.

The information indicating the surrounding information may include the following information:
Information indicating whether the in-vehicle communication device 10 detects radio waves from the mobile terminal 5.
Information indicating whether the intensity (electric field intensity) of radio waves received from the mobile terminal 5 exceeds a threshold.
Information indicating whether the in-vehicle communication device 10 and the mobile terminal 5 are connected.

Note that the condition related to the surrounding environment may be set on the basis of a combination of two or more of the above information.

Further, as illustrated in the fourth processing example (FIG. 6), when a charging mode corresponds to the quick mode and the time length between the current time and the scheduled charging completion time of the secondary cell 8 is equal to or below a threshold, it is possible to employ a configuration where the value of transmission power for wireless communication is set to a value smaller than the maximum value of the transmission power.

Further, as illustrated in the fourth processing example, it is also possible to employ a configuration where, when a charging mode corresponds to the quick mode and the time length between the current time and the scheduled charging completion time of the secondary cell 8 exceeds a threshold, the value of transmission power for wireless communication is set to a value indicating the maximum value of the transmission power.

Note that the processing orders in the sequence diagrams and flowcharts in this specification may be changed as long as no contradictions arise.

The processing or means described in this disclosure may be freely combined together for implementation as long as no technological contradictions arise. Further, the processing described as being performed by one device may be borne and performed by a plurality of devices. Alternatively, the processing described as being performed by different devices may be performed by one device. In a computer system, it is possible to flexibly change how respective functions are realized by hardware configurations (server configurations).

This disclosure may also be realized by supplying a computer program with the functions described in the above embodiment to a computer and causing one or more processors provided in the computer to read and run the program. Such a computer program may be provided to a computer via a non-transitory computer-readable medium connectable to a computer system bus, or may be provided to a computer via a network. The non-transitory computer-readable medium includes, for example, any type of disk such as a magnetic disk (such as a floppy (TM) disk and a Hard Disk Drive (HDD)), and an optical disk (such as a CD-ROM, a DVD disc, and a Blu-ray disc), and any type of medium suitable for storing electronic instructions such as a Read-Only Memory (ROM), a Random Access Memory (RAM), an EPROM, an EEPROM, a magnetic card, a flash memory, and an optical card.

What is claimed is:

1. An in-vehicle communication device mounted in a vehicle, comprising:
a control unit that determines transmission power for wireless communication on a basis of whether a current charging mode corresponds to a first mode or a second mode with respect to the wireless communication using the in-vehicle communication device performed when the vehicle is in a parked state and in a charging state where a secondary cell that supplies power to a motor provided in the vehicle is being charged.

2. The in-vehicle communication device according to claim 1, wherein,
when the charging mode corresponds to the first mode, a value of the transmission power for the wireless communication is set to a value smaller than a maximum value of the transmission power.

3. The in-vehicle communication device according to claim 1, wherein,
when the charging mode corresponds to the first mode, a value of the transmission power for the wireless communication is set to a maximum value of the transmission power.

4. The in-vehicle communication device according to claim 1, wherein,
when the charging mode corresponds to the first mode, the control unit determines whether an upper limit of the transmission power for the wireless communication is set to a value smaller than a maximum value of the transmission power or the transmission power is fixed at the maximum value, on a basis of information indicating whether the maximum value is usable or information indicating a surrounding environment of the in-vehicle communication device.

5. The in-vehicle communication device according to claim 4, wherein
the information indicating the surrounding environment includes information indicating whether the in-vehicle communication device detects radio waves from a mobile terminal, information indicating whether intensity of the radio waves received from the mobile terminal exceeds a threshold, or information indicating whether the in-vehicle communication device and the mobile terminal are connected.

6. The in-vehicle communication device according to claim 1, wherein,
when the charging mode corresponds to the first mode and a time length between a current time and a scheduled charging completion time of the secondary cell is equal to or below a threshold, a value of the transmission power for the wireless communication is set to a value smaller than a maximum value of the transmission power.

7. The in-vehicle communication device according to claim 1, wherein,
when the charging mode corresponds to the first mode and a time length between a current time and a scheduled charging completion time of the secondary cell exceeds a threshold, a value of the transmission power for the wireless communication is set to a value indicating a maximum value of the transmission power.

8. A communication control method comprising:
determining, by an in-vehicle communication device mounted in a vehicle, transmission power for wireless communication on a basis of whether a current charging mode corresponds to a first mode or a second mode with respect to the wireless communication using the in-vehicle communication device performed when the vehicle is in a parked state and in a charging state where a secondary cell that supplies power to a motor provided in the vehicle is being charged.

9. The communication control method according to claim 8, wherein,
when the charging mode corresponds to the first mode, a value of the transmission power for the wireless communication is set to a value smaller than a maximum value of the transmission power.

10. The communication control method according to claim 8, wherein,
when the charging mode corresponds to the first mode, a value of the transmission power for the wireless communication is set to a maximum value of the transmission power.

11. The communication control method according to claim 8, wherein,
when the charging mode corresponds to the first mode, the in-vehicle communication device determines whether an upper limit of the transmission power for the wireless communication is set to a value smaller than a maximum value of the transmission power or the transmission power is fixed at the maximum value, on a basis of information indicating whether the maximum value is usable or information indicating a surrounding environment of the in-vehicle communication device.

12. The communication control method according to claim 11, wherein
the information indicating the surrounding environment includes information indicating whether the in-vehicle communication device detects radio waves from a mobile terminal, information indicating whether intensity of the radio waves received from the mobile terminal exceeds a threshold, or information indicating whether the in-vehicle communication device and the mobile terminal are connected.

13. The in-vehicle communication device according to claim 8, wherein,
when the charging mode corresponds to the first mode and a time length between a current time and a scheduled charging completion time of the secondary cell is equal to or below a threshold, a value of the transmission power for the wireless communication is set to a value smaller than a maximum value of the transmission power.

14. The communication control method according to claim 8, wherein,
when the charging mode corresponds to the first mode and a time length between a current time and a scheduled charging completion time of the secondary cell exceeds a threshold, a value of the transmission power for the wireless communication is set to a value indicating a maximum value of the transmission power.

15. A non-transitory computer-readable storage medium storing a program that causes a computer of an in-vehicle communication device mounted in a vehicle to perform:
a step of determining transmission power for wireless communication on a basis of whether a current charging mode corresponds to a first mode or a second mode with respect to the wireless communication using the in-vehicle communication device performed when the vehicle is in a parked state and in a charging state where a secondary cell that supplies power to a motor provided in the vehicle is being charged.

16. The non-transitory computer-readable storage medium storing the program according to claim 15, wherein
the computer is caused to set a value smaller than a maximum value of the transmission power as a value of the transmission power for the wireless communication when the charging mode corresponds to the first mode.

17. The non-transitory computer-readable storage medium storing the program according to claim 15, wherein
the computer is caused to set a maximum value of the transmission power as a value of the transmission power for the wireless communication when the charging mode corresponds to the first mode.

18. The non-transitory computer-readable storage medium storing the program according to claim 15, wherein
the computer is caused to perform a step of determining whether an upper limit of the transmission power for the wireless communication is set to a value smaller than a maximum value of the transmission power or the transmission power is fixed at the maximum value when the charging mode corresponds to the first mode, on a basis of information indicating whether the maximum value is usable or information indicating a surrounding environment of the in-vehicle communication device.

19. The non-transitory computer-readable storage medium storing the program according to claim 15, wherein
the computer is caused to set a value smaller than a maximum value of the transmission power as a value of the transmission power for the wireless communication when the charging mode corresponds to the first mode and a time length between a current time and a scheduled charging completion time of the secondary cell is equal to or below a threshold.

20. The non-transitory computer-readable storage medium storing the program according to claim 15, wherein
the computer is caused to set a maximum value of the transmission power as a value of the transmission power for the wireless communication when the charging mode corresponds to the first mode and a time length between a current time and a scheduled charging completion time of the secondary cell exceeds a threshold.
